(19) United States
(12) Patent Application Publication
(10) Pub. No.: US 2006/0150756 A1
(43) Pub. Date: Jul. 13, 2006

(54) Method and device for determining the sitting comfort a seat cushion, which is perceived by a person

(76) Inventors: Lothar Kassing, Nufringen (DE); Vasilios Orizaris, Renningen (DE); Karl Pfahler, Stuttgart (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/536,784

(22) PCT Filed: Oct. 24, 2003
(86) PCT No.: PCT/EP03/11803

§ 371 Date: Dec. 6, 2005

(30) Foreign Application Priority Data
Nov. 28, 2002 (DE) 10255445.5

(51) Int. Cl. G01M 19/00; G01L 5/00

(52) U.S. Cl. 73/865.9; 73/862.046; 702/196

(57) ABSTRACT

A method for determining seat comfort includes the steps of measuring pressure distribution over a seat surface using a pressure sensing system, measuring an actual deformation of the seat surface using a deformation sensing system, and computing a value of seat comfort on the basis of the measured actual deformation of the seat surface and the measured pressure distribution of the seat surface. Apparatus for determining seat comfort includes a pressure sensing system for measuring a pressure distribution on a seat surface, a deformation sensory system for measuring an actual deformation of the seat surface, and an evaluation unit for computing seat comfort from the measured pressure distribution and the measured deformation of the seat surface.

### BACKGROUND AND SUMMARY OF THE INVENTION

The invention relates to a method and to an apparatus for determining the sitting comfort of an upholstered chair when occupied, and especially of the perceived softness of the seat upholstery of a motor vehicle chair.

For the manufacture of high-quality seat padding, especially seat padding of motor vehicle seats, which must satisfy high comfort requirements from the user's viewpoint, in regard to their useful life and the situation in which they are used, methods and apparatus are known which enable an evaluation and measurement of comfort or of factors relevant to comfort.

Problematic is the repeatability of the measurement results, and the significance of such measurements since they represent a relatively subjective impression, such as the comfort felt when one first sits down on seat upholstery and when one has been sitting thereon for long periods. Therefore it is still customary in the designing and quality testing of such seats to find out the perceived sitting comfort by using test persons, preferably a plurality of such persons so as to avoid subjective impressions and exceptions by using an adequate statistical population. This kind of procedure is time-consuming and expensive, and yet it provides no repeatable results that might be useful in the designing and manufacture of new seat upholstery.

German Patent DE 196 01 974 C2 discloses a method is disclosed for learning the seating comfort of seat upholstery, in which a measuring mat is employed which contains a plurality of individual pressure sensors, and a value of the seating comfort of the seat upholstery can be determined. By a group-wise combination into one of an array of pressure sensors according to anthropomorphic areas and a corresponding area-specific evaluation of the pressures measured each time, the values reflecting the particular pressure comfort of the seat upholstery are obtained. Even though this method offers values to some extent based on a seating pressure distribution of the human body seated for a fairly long time, the method is entirely unsuitable for offering a measurement of repeatable values of seating comfort when a person first sits down, that is, in the initial phase of the person's sitting.

German Patent DE 196 01 972 C2 discloses a method is disclosed for detecting the surface contour of stressed seat upholstery, which permits measuring the surface of the seat upholstery by means of a measuring mat by building up a vacuum after a deformation of the seat cushion. The deformation of the surface contour can thus be reflected in the form of a multi-dimensional image or a matrix. It is a disadvantage that no conclusions can be derived just from measuring the deformation of the seat surface as to the comfort actually perceived by a person who sits thereon.

The invention, on the other hand, is addressed to the problem of devising a method as well as an apparatus for determining the perceived seat comfort upon sitting down onto seat upholstery, which will permit on the one hand an objectivized, repeatable measurement of the seat comfort, and on the other hand can be carried out without complex experimental set-ups and will permit performance of tests by a number of test subjects.

This problem is solved by a method described and claimed hereinafter as well as by an apparatus described and claimed hereinafter.

The method for determining the sitting comfort of seat upholstery when the latter is stressed, especially the perceived softness of a car seat, by stressing a given seat area and contour with the pressure and distribution corresponding to the sitting down of a person, is characterized by the measurement of the distribution of pressure over the seat surface by mans of a pressure sensing system; measuring the actual deformation of the seat surface by means of a distance or deformation sensing system; and by computing, from the measured deformation and the measured pressure distribution of the seat upholstery, a value for the seat comfort perceived when sitting down thereon. By combining a pressure measurement on the seat surface with a measurement of its deformation, the invention makes it possible to compute a softness and elasticity rating which permits an objective and repeatable judgment of the softness and thus of the seat comfort which will be perceived by a person upon sitting down on the car seat. A novel method of measurement is thereby made available, which can be used to advantage in connection with the development of seat upholstery and with quality assurance in series production. The method and procedure of determining sitting comfort permits an objective and repeatable judgment of the actual comfort perception of a user, also when, and precisely as he sits down. Although the simple measurement of the distribution of pressure on a car seat is sufficient to judge its long-term comfort, it has developed that this previously known method is inadequate for judging the sensation of comfort as one sits down on a seat, that is to say, in the initial phase of taking a seat. With the method of the invention it is for the first time possible to judge this sensation of comfort by means of test persons in a reliable and repeatable manner. By a mathematical combination of a measured seat pressure distribution over the seat cushioning and the contour produced by sitting down, that is, the actual shaping of the seat by such action, a kind of three-dimensional modulus of elasticity can be calculated in an analogy to the formula of Hook's Law: f=D·X, wherein F is the spring force, X the spring travel, and D the elasticity constant. The pressures measured are entered as spring travel, the measured deformation of the seat surface as the spring stroke, so that the formula can be used to compute the softness in the form of a matrix elasticity value similar to the elastic constant D. By a simple matrix calculation a three-dimensional softness value can thus be determined by the method of the invention.

According to an advantageous embodiment of the method of the invention, the computation of a softness matrix value D is performed for judging seat comfort when the occupant sits down from a measured pressure distribution matrix P and a measured deformation matrix X in proportion to the actual seat surface. The pressure distribution and the deformation of the seat surface are preferably determined in this case by an equal number of measurement points, for example over about 1,000 measuring points, the distribution and arrangement of the sensors being made substantially accordingly.

In an advantageous embodiment of the method of the invention, the computed seat comfort value is represented as a multidimensional elasticity matrix in a three-dimensional representation. The multidimensional representation can be made, for example, by three coordinates in space, the X and Y coordinates reflecting the seat area and the Z coordinates, for example, elasticity values in the unit N/cm². The three-dimensional representation can alternatively be made by color fields which are entered as third dimension into a bi-dimensional surface raster of the seat contour.

In an advantageous embodiment of the invention, a first measuring mat is used having a plurality of measuring sensors in the size of the seat surface for measuring the pressure distribution, and then a second measuring mat is used for measuring the seat surface deformation, the first and the second measuring mat having substantially the same number of measurement points and are positioned according to their layer. The calculation of the seat comfort value at substantially the same number of measuring points is relatively simple, and can be performed by any suitable means by which matrix computations are possible.

According to an advantageous embodiment of the invention, the deformation of the seat shape is measured by forming a difference from a three-dimensional imaging of the seat surface in the sitting-down case. The result is a relative deformation per point of measurement, so that errors due to an already slightly deformed seat surface are prevented.

The apparatus of the invention with the characteristics of claim 6 has means for applying to a seat surface a pressure load and distribution corresponding to the sitting down of a person, and it is characterized in that a pressure sensing system is provided for measuring a distribution of pressure on the seat surface, a deformation sensing system for measuring the actual deformation of the seat surface, and an evaluating unit for calculating a value of the seat comfort from the measured pressure distribution and the measured deformation of the seat surface. The apparatus is thereby extremely compact and can be operated by the simple placement on a given car seat and then operate it by having a test person sit down or by using an additional test apparatus. In this case, first the pressure sensing device alone and then the deformation sensing device is laid onto the particular seat. The evaluating unit is adapted to store the measured values and process them on the spot, or later, for evaluation.

In an advantageous embodiment, the apparatus according to the invention is provided with a pressure sensing device in the form of a measuring mat which can be fastened onto the seat surface, and the deformation sensing device is provided in the form of a second measuring mat which can be fastened to the seat surface, and which can maintain the deformation after the test person has sat down. Providing the particular sensing system in the form of flat mats of essentially the same size as the seat surface has the advantage that a sitting-down measurement can be made with actual test persons or with a single person in order to determine an objectivized seat comfort value. The sensing mats must merely be placed onto a given seat and operated successively by means of a test person or a special apparatus which simulates the sitting down of a person.

According to an advantageous embodiment of the invention, the evaluating unit has a computing means to perform matrix computations. The multidimensional results of the pressure measurement and the deformation measurement can be further processed by matrix multiplication and division. It is thus possible to obtain a three-dimensional matrix result which can be calculated like an elasticity module matrix from the elasticity constant from Hook's Law. More about the method of computation with matrices will be described further below in embodiments of the present invention.

In an advantageous embodiment of the invention, an output and display unit is provided, by means of which three-dimensional measurement and result matrices can be displayed. For the judgment or for the comparison of a plurality of car seats or drafts of car seats being developed, a user of the apparatus or the designing engineer can judge their actual comfort by a simple optical comparison of the particular seat comfort values in the form of matrices. In this way design failures are avoided, and a repeatable, objective judgment of seat softness or comfort can be made without a great number of tests.

Additional advantages and features of the invention are to be found in the following description, in which the invention is further described and explained with the aid of embodiments represented in the drawing.

### BRIEF DESCRIPTION OF THE DRAWINGS

FIGS. 1a to 1c illustrate the steps in an embodiment of the method of the invention, showing the measurement of the deformation of a seat structure; and

FIG. 2 illustrates the determination of pressure distribution in an example of an embodiment of the invention, serving together with the seat contour measurement according to FIGS. 1a to 1c for the calculation of a value for seat softness.

### DETAILED DESCRIPTION OF THE DRAWINGS

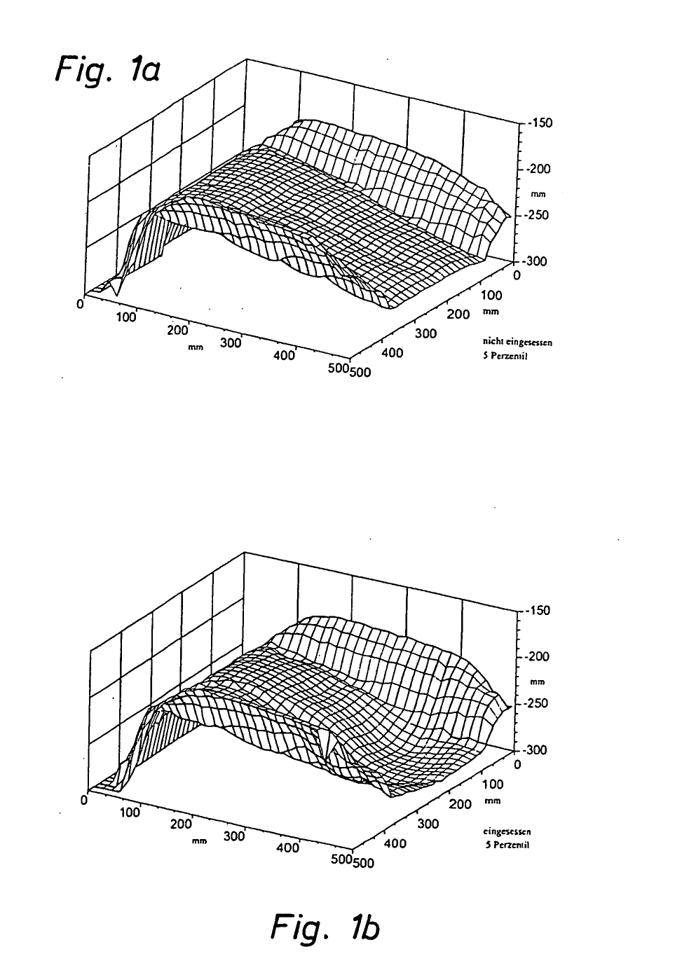

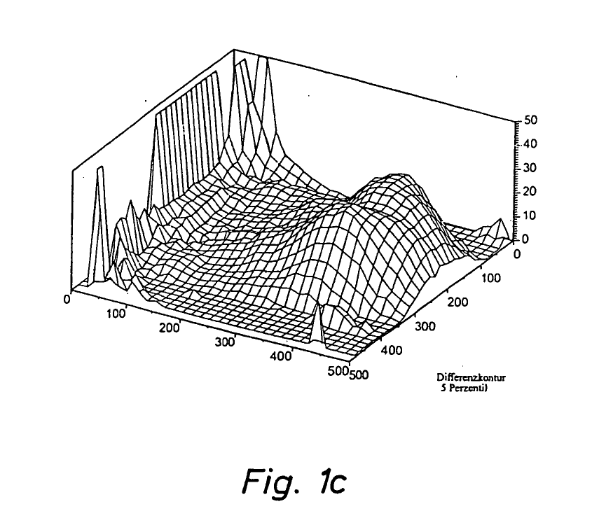

In FIG. 1a is shown a seat contour in the form of a tri-dimensional drawing, in the case of no one sitting down, that is, without a person having sat down on the seat, and, respectively, when a special device to simulate a person sitting on the seat has been used. The three-dimensional representation of the seat shape is created by an evaluation of a measurement by a measuring mat (not shown), like the one described, for example, in German Patent DE 196 01 972 C2. In this case a plurality of measurement points has been detected by a measuring mat which after it has been placed can be fixed and stiffened in any state of deformation, by applying a vacuum. Of course, any other kind of measurement of the deformation of the seat surface or seat shape can be used. In FIG. 1b the same car seat as shown in FIG. 1a is represented, but here the seat shape is shown in the deformed state, i.e., in the state in which it is sat upon. The measurement is performed in the same manner as before. In FIG. 1c there is shown the actual seat cushion deformation, by differentiation of the data matrices which result from the values in FIGS. 1a and 1b. For example, about 1,000 individual measurement points are used, which are uniformly spread out over the seat surfaces to be measured. From the differential shape of a deformation of the surface, that is, the actual cushion deformation, the computation or determination, according to the invention, of the perceived seat comfort is accomplished as and when it is sat upon in this embodiment, taking into account data on a seat pressure distribution, as described below.

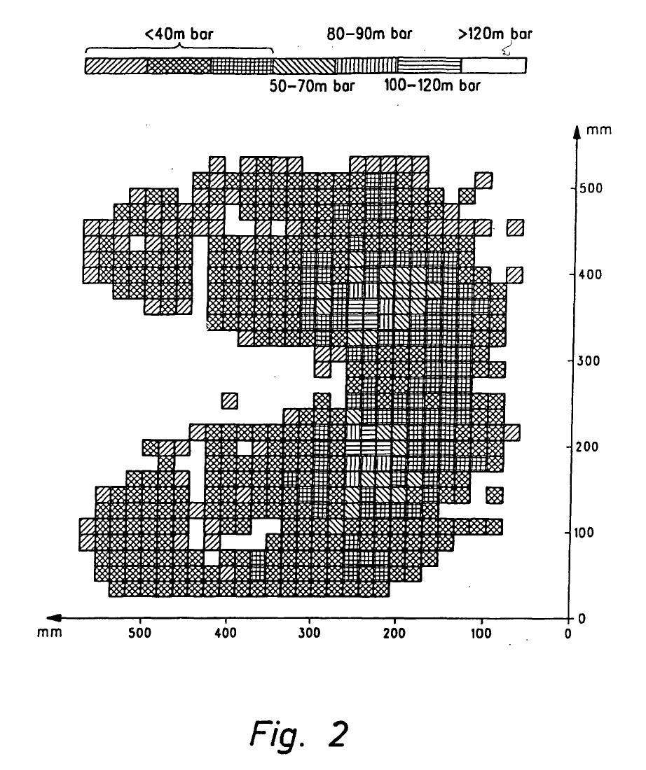

In FIG. 2 there is shown by way of example the result of a pressure measurement such as can be used in one step by the method of the invention. By using a measuring mat with a pressure sensing system, a plurality of pressure measuring points are measured, preferably as many as in the previous contour measurement, that is to say, about 1,000 measuring points, for example, when a test person sits down on a given cushion of a car seat. The points of measurement of the pressure distribution result in a pressure distribution pattern, similar to the one shown in FIG. 2. To measure the pressure distribution a measuring mat can be used, for example, like the one described in German Patent DE 195 01 974 C2. Other methods of pressure measurement can be used in the same way for determining a seat comfort value according to the invention.

Hereinafter are given the results of the contour (deformation) measurement and pressure measurement, as described before, combined by a mathematical process. The data matrices of the change in shape and pressure distribution that occur when the seat is first sat upon are plotted by an analogy to Hook's formula:
F=D·X
wherein F is the spring force, X is the spring compression length, and D the elastic constant, to obtain a softness matrix. For this purpose the above formula known as Hook's law, is modified as follows:
P/A=D★X
to
D=1/A★P:X
wherein P is the pressure distribution matrix, A the active pressure sensor surface, X the deformation matrix and D the softness matrix. The data matrices are evaluated by matrix multiplication and division by insertion into the above formula to obtain the softness matrix D. The result is a matrix value D which can be represented as a three-dimensional elasticity constant with the unit N/m². This seat softness or comfort matrix D can be represented similarly to the pressure distribution represented in FIG. 2, for example by colored areas representing different degrees of softness. Thus, by means of the method of the invention, a repeatable and objectivized expression can be made of the perceived softness of a seat cushion as it is sat upon. By specifying a seat softness matrix pattern D, loading manuals can be created which can be used for preparing designs and quality control for seats. The development of seat cushioning which offer the user an approximately uniform feeling of comfort both when he sits down and when he sits for long periods is thus facilitated.

1-10. (canceled)

11. A method for determining seat comfort, comprising
measuring pressure distribution over a seat surface using a pressure sensing system,
measuring an actual deformation of the seat surface using a deformation sensing system, and
computing a value of seat comfort on the basis of the measured actual deformation of the seat surface and the measured pressure distribution of the seat surface.

12. The method according to claim 11, further comprising computing a softness matrix value of seat comfort from a measured pressure distribution matrix and a measured deformation matrix of the seat surface.

13. The method according to claim 12, further comprising displaying the computed seat comfort value in a three-dimensional representation as a multi-dimensional elasticity matrix over the seat surface.

14. The method according to claim 11, further comprising using a first measuring mat, having a plurality of measuring sensors, of the size of the seat surface to measure the pressure distribution and using a second measuring mat for measuring the seat surface deformation, the first and the second measuring mats having substantially the same number of points of measurement and each being positioned as a layer.

15. The method according to claim 11, further comprising measuring the deformation of the seat surface by forming a difference from a matrix value of a three-dimensional imaging of the seat surface in an unoccupied case and from a matrix value of a three-dimensional imaging of an upper surface of the seat upon its initial occupation.

16. Apparatus for determining seat comfort, comprising:
a pressure sensing system for measuring a pressure distribution on a seat surface,
a deformation sensory system for measuring an actual deformation of the seat surface, and
an evaluation unit for computing seat comfort from the measured pressure distribution and the measured deformation of the seat surface.

17. Apparatus according to claim 16, wherein the pressure sensing system comprises a first measuring mat which is designed to be fastened on the seat surface, and wherein the deformation sensing system comprises a second measuring mat which is designed to be fastened on the seat surface to retain a deformation of the seat surface.

18. Apparatus according claim 17, wherein the evaluation unit has a calculating device for performing matrix calculations.

19. Apparatus according to claim 18, further comprising an output and display unit to display three-dimensional measured value matrices.

20. Apparatus according to claim 16, further comprising means for acting upon a seat surface with a pressure application and distribution corresponding to a sitting down of a person.
